(19) United States
(12) Patent Application Publication
(10) Pub. No.: US 2016/0183083 A1
(43) Pub. Date: Jun. 23, 2016

(54) USER EQUIPMENT AND METHOD FOR DYNAMIC INTERNET PROTOCOL MULTIMEDIA SUBSYSTEM (IMS) REGISTRATION

(71) Applicant: Motorola Solutions, Inc., Schaumburg, IL (US)

(72) Inventors: ADAM C. LEWIS, Buffalo Grove, IL (US); PAULA TJANDRA, Inverness, IL (US); KAREN M. UPP, Bartlett, IL (US)

(21) Appl. No.: 14/577,775

(22) Filed: Dec. 19, 2014

(51) Int. Cl. H04W 8/28; H04W 60/04; H04L 29/06

(52) U.S. Cl. CPC H04W 8/28; H04L 65/1016; H04L 65/1073; H04W 60/04

(57) ABSTRACT

A method of Internet Protocol (IP) Multimedia Subsystem (IMS) registration and a user equipment (UE) enable dynamic assignment of a Mobile Subscriber Integrated Services Digital Network-Number (MSISDN) to the UE. An input identifying a user of the UE is received at the UE. One or more credentials based on the input are transmitted from the UE to an identity management system. User data comprising a MSISDN attribute corresponding to the user are received at the UE from the identity management system. An IP Multimedia Private Identity (IMPI) associated with the UE and an IP Multimedia Public Identity (IMPU) based on the MSISDN attribute are then transmitted from the UE to a registrar.

### BACKGROUND OF THE INVENTION

In mobile telecommunications, a subscriber is often identified by a Mobile Subscriber Integrated Services Digital Network-Number (MSISDN) and an International Mobile Subscriber Identity (IMSI). The MSISDN is used to route calls to a user equipment (UE) of the subscriber. The IMSI identifies a subscriber to a telecommunications network and is typically hardcoded to a Universal Integrated Circuit Card (UICC), such as a Subscriber Identity Module (SIM), that is inserted into the UE. The MSISDN is typically bound to the IMSI by a service provider when the UICC is purchased.

Many modern telecommunication systems are moving toward using Internet Protocol Multimedia Subsystem (IMS), which is an architectural framework for delivering multimedia services over internet protocol (IP). IMS aims to provide all mobile telecommunications over IP. For example, in some applications, Voice over Long Term Evolution (VoLTE), Short Message Service (SMS) and Multimedia Messaging Service (MMS) all rely on IMS.

A subscriber on IMS is identified by an IP private identity (IMPI) and an IP public identity (IMPU). The IMPI and IMPU are typically stored on a UICC called an IP Multimedia Services Identity Module (ISIM). During IMS registration, the IMPI and IMPU are sent to a registrar which includes a Home Subscriber Server (HSS) such that, for example, when an IMS voice call is placed, the call can be routed to the proper UE.

One limitation of the above configuration is that in some applications that rely on IMS, the UE is shared among multiple users. Therefore, the number or address at which a specific user can be contacted will vary. For example, in a public safety network, such as First Responder Network (FirstNet), a UE can be shared between multiple users from an agency.

There is a desire for a specific user to be reachable via the same number regardless of which UE they are in possession. Accordingly, there is a need for a UE and a method for dynamic IMS registration.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system for dynamic IMS registration in accordance with some embodiments.

FIG. 2 is a flowchart of a method for IMS registration in accordance with some embodiments.

FIG. 3 is a message sequence chart illustrating a detailed example of a method for IMS registration in accordance with some embodiments.

FIG. 4 is a message sequence chart illustrating a detailed example of a method for IMS deregistration in accordance with some embodiments.

FIG. 5 is a schematic of a user equipment (UE) in accordance with some embodiments.

FIG. 6 is a schematic of an identity management system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

According to certain embodiments, the present invention resides in a method for dynamic Internet Protocol (IP) Multimedia Subsystem (IMS) registration. The method comprises the following: An input identifying a user of a user equipment (UE) is received at the UE. One or more credentials based on the input are transmitted from the UE to an identity management system. User data comprising a Mobile Subscriber Integrated Services Digital Network-Number (MSISDN) attribute corresponding to the user is then received at the UE from the identity management system. An IP Multimedia Private Identity (IMPI) associated with the UE and an IP Multimedia Public Identity (IMPU) based on the MSISDN attribute are transmitted from the UE to a registrar.

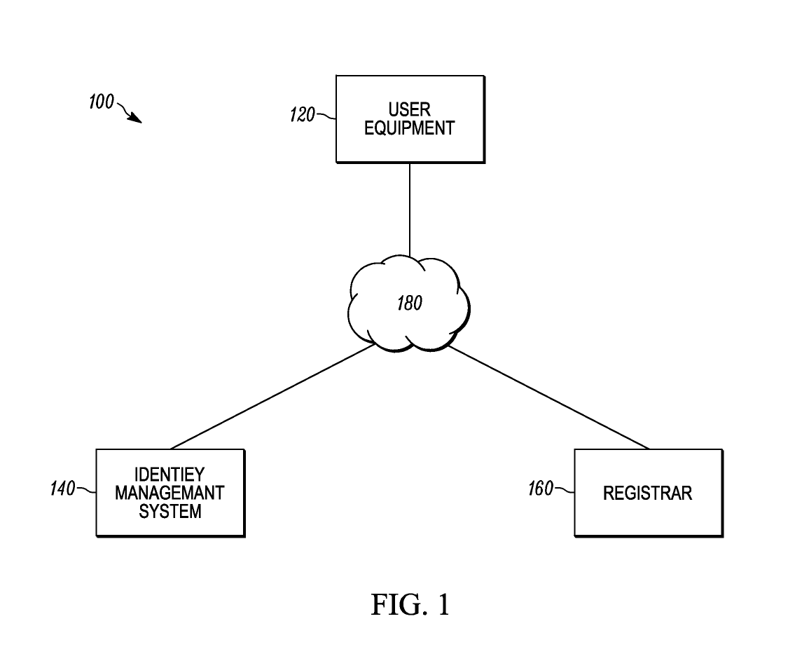

FIG. 1 is a block diagram of a system 100 for dynamic IMS registration according to some embodiments. The system 100 comprises one or more UE 120, an identity management system 140 and a registrar 160. The identity management system 140 and the registrar 160 are in communication with the UE 120 via a communications network 180.

The UE 120 is, for example, a mobile telephone, a smartphone, a notebook or tablet computer comprising a mobile broadband adapter, or any other device that is suitable for IMS registration. The UE 120 may be shared among multiple users, for example, between first responders within a public safety agency.

The identity management system 140 stores user data which can be utilized by the UE 120 to build a richer user experience. The user data includes, for example, MSISDN attributes and home IMS domain attributes corresponding to the users. In some embodiments, the identity management system 140 is a home identity management system, for example, a server of an agency associated with the user to which the user authenticates.

The registrar 160 performs IMS registration by registering a binding between an IMPI and an IMPU. The registrar 160 is configured to receive the IMPI and the IMPU from the UE 120.

The communications network 180 is, for example, a telecommunications network, a wireless network, or another network that supports IP.

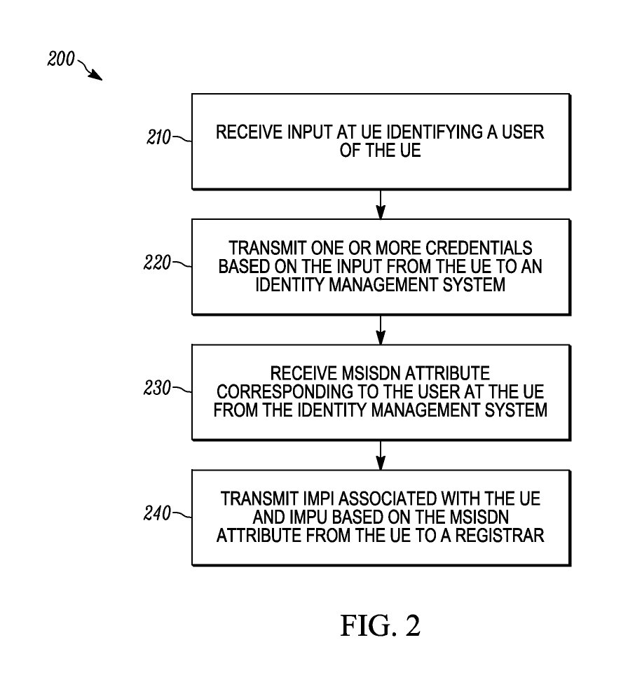

FIG. 2 is a flowchart of a method 200 of IMS registration according to some embodiments. For example, the method 200 is implemented on the system 100. The method 200 comprises the following steps.

At step 210, an input is received at a UE identifying a user of the UE. The input includes, for example, a username, a password, a 2-factor authentication, a biometric input, a smart card input and/or another unique identifier associated with the user. The input can also include one or more other factors associated with the user, for example, something that the user knows, something that the user has, and/or something the user is. In some embodiments, receiving an input identifying a user of the UE forms part of a log in of the user to the UE.

At step 220, one or more credentials based on the input are transmitted from the UE to an identity management system. In some embodiments, transmitting the one or more credentials from the UE to the identity management system forms part of an authentication to a home identity management system.

At step 230, user data comprising a MSISDN attribute corresponding to the user is then received at the UE from the identity management system. In some embodiments, the user data further comprises a home IMS domain attribute.

At step 240, an IMPI associated with the UE and an IMPU based on the MSISDN attribute are transmitted from the UE to a registrar. In some embodiments, the IMPU is also based on the home IMS domain attribute.

In some embodiments, the IMPU is generated at the UE based on the MSISDN attribute and/or the home IMS domain attribute. In alternative embodiments, the user data comprises the IMPU based on the MSISDN attribute and/or the home IMS domain attribute.

In preferred embodiments, authentication of the user with the identity management system is required to perform IMS registration, where IMS registration comprises transmitting the IMPI and IMPU from the UE to the registrar. For example, when the user is not authenticated with the identity management system, only emergency calls can be triggered by the UE.

In some embodiments, a request to log the user out of the UE is received at the UE. For example, a request to log the user out of the UE is received via an input to the UE when the user is finished using the UE. In response to receiving the request to log the user out of the UE, a request for IMS deregistration is transmitted from the UE to the registrar. In some embodiments, a request to deauthenicate the user from the identity management system is also transmitted from the UE to the identity management system.

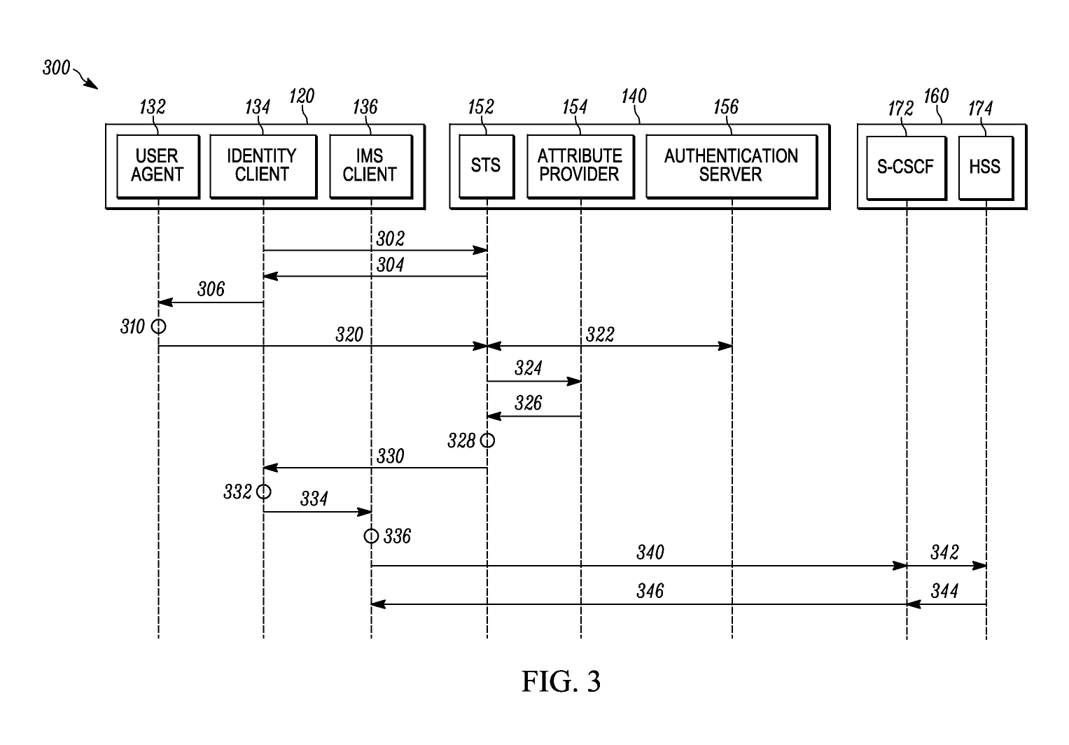

FIG. 3 is a message sequence chart illustrating a detailed example of a method 300 for IMS registration in accordance with some embodiments. The method 300 comprises the following steps.

At step 302, a token request is transmitted from an identity client 134 of the UE 120 to a security token service (STS) 152 of the identity management system 140. The token request requests a token for a user of the UE 120. The identity client 134 comprises, for example, Mobile Subscriber Identity (MSI) software and/or a single sign on (SSO) client.

At step 304, a request for authentication credentials of the user is received at the identity client 134 from the STS 152.

At step 306, the identity client 134 utilizes a user agent 132 to interact with and collect credentials from the user of the UE 120.

At step 310, the user agent 132 receives an input identifying the user of the UE 120.

At step 320, one or more credentials based on the input are transmitted from the user agent 132 to the STS 152. In some embodiments, the one or more credentials are received at the identity client 134 from the user agent 132 and transmitted from the identity client 134 to the STS 152.

At step 322, the STS 152 validates the one or more credentials with an authentication server 156 of the identity management system 140. In some embodiments, this validation forms part of an authentication to a home identity management system.

At step 324, the STS 152 transmits a request for one or more attributes including user data to an attribute provider (AP) 154 of the identity management system 140. The user data includes an MSISDN attribute and preferably a home IMS domain attribute. In some embodiments, the STS 152 queries an attribute storage function of the AP 154, which contains a binding between the user identity and one or more attributes associated with the user's identity. For example, the attribute storage function searches a database using a corresponding user identity as an index.

At step 326, the one or more attributes are received at the STS 152 from the AP 154. For example, the AP 154 returns the MSISDN and/or the home IMS domain attribute.

At step 328, the STS 152 generates a token. The token is, for example, a JavaScript Object Notation (JSON) Web Token (JWT). The token comprises the MSISDN attribute. In some embodiments, the token also comprises the home IMS home domain attribute. For example, the token comprises the corresponding user identity as a subject and the MSISDN attribute and/or the home IMS domain attribute as attributes of the user's identity. In some embodiments, an IMPU that is based on the MSISDN attribute and/or the home IMS domain attribute is generated at the STS 152 and the token comprises the IMPU as an attribute.

At step 330, the identity client 134 receives the token from the STS 152.

At step 332, the identity client 134 generates an IMPU based on the MSISDN. In some embodiments, the IMPU is also based on the home IMS domain attribute. Alternatively, if the IMPU was communicated as an attribute in the token issued by the STS 152, the identity client 134 extracts the IMPU provided in the token. For example, the IMPU can have the form: SIP:msisdn@domain.

At step 334, the identity client 134 provides the IMPU to an IMS client 136 of the UE 120. In some embodiments, the IMS client 136 is an IMS stack on the UE 120. For example, the IMPU is programmatically passed from the identity client 134 to the IMS client 136 via an application programming interface (API).

At step 336, the IMS client 136 generates a registration message which includes the IMPU and an IMPI of the UE 120. For example, the registration message is a Session Initiation Protocol (SIP) registration message requesting a binding between the IMPI and the IMPU.

At step 340, the IMPU and IMPI are transmitted from the IMS client 136 to a Serving Call Session Control Function (S-CSCF) 172 of the registrar 160.

At step 342, a binding between the IMPU and IMPI is transmitted from the S-CSCF 172 to a Home Subscriber Server (HSS) 174 of the registrar 160.

At step 344, the HSS 174 provides a phone number associated with the binding to the S-CSCF 172.

At step 346, a confirmation that a binding between the IMPI and the IMPU is authorized is transmitted from the S-CSCF 172 to the IMS client 136.

As shown, the general steps 210, 220, 230, 240 of FIG. 2 correspond, respectively, with the more particular steps 310, 320, 330, 340 of FIG. 3.

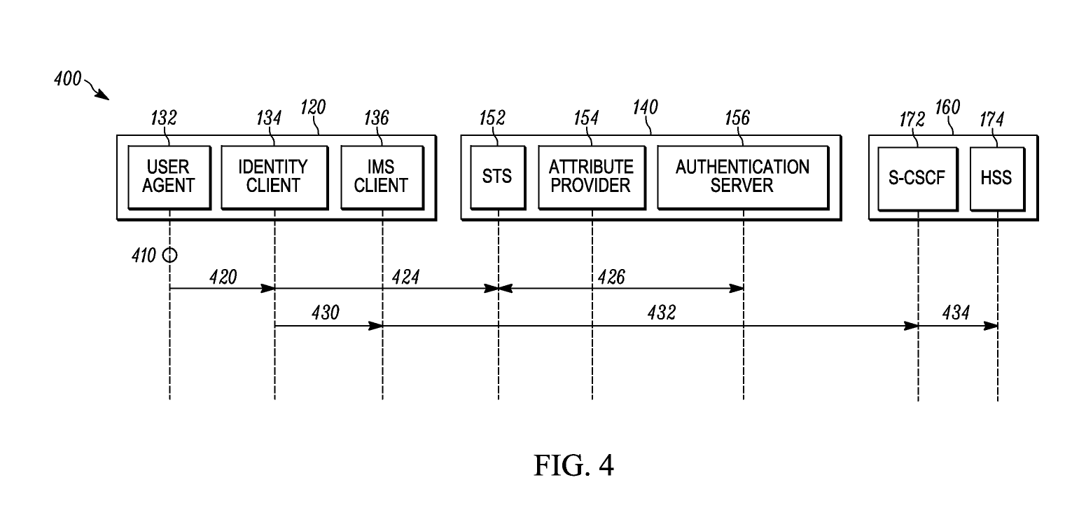

FIG. 4 is a message sequence chart illustrating a detailed example of a method 400 for IMS deregistration in accordance with some embodiments. The method 400 comprises the following steps.

At step 410, a request to log the user out of the UE 120 is received via the user agent 132 of the UE 120.

At step 420, the identity client 134 of the UE 120, which utilizes the user agent 132 to interact with the user of the UE 120, receives the request to log the user out of the UE from the user agent 132.

At step 424, a deauthentication request is transmitted from the identity client 134 to the STS 152 of the identity management system 140.

At step 426, the STS 152 deauthenicates the user via the authentication server 156 of the identity management system 140.

At step 430, the identity client 134 transmits a log out event notification to the IMS client 136 of the UE 120.

At step 432, the IMS client 136 transmits a request for IMS deregistration to the S-CSCF 172 of the registrar 160.

At step 434, a request to unbind the IMPU and IMPI is transmitted from the S-CSCF 172 to the HSS 174 of the registrar 160.

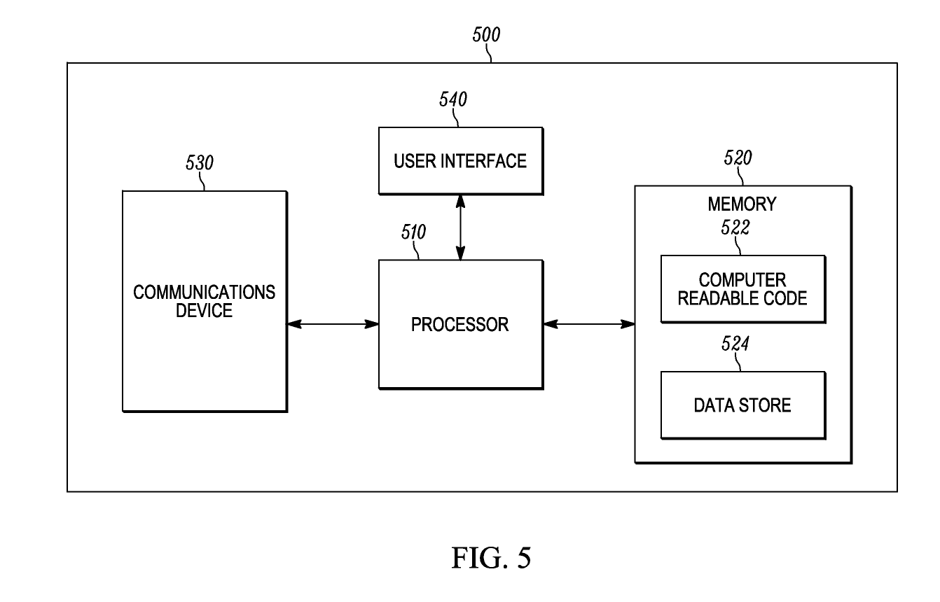

FIG. 5 is a schematic of a UE 500 in accordance with some embodiments. The UE 500 is, for example, identical to the UE 120.

The UE 500 comprises a processor 510 and a memory 520 coupled to the processor 510. The memory 520 comprises instruction code 522 for implementing various aspects of the present invention including various methods and functions of the embodiments described herein. The processor 510 processes the computer instruction code 522 stored in the memory 520 and executes corresponding instructions.

The memory 520 can also include a data store 524 to store data such as the data used in the embodiments. As will be understood by a person skilled in the art, a single memory, such as the memory 520, can be used to store both dynamic and static data. The structure of the memory 520 is well known to those skilled in the art and can include a basic input/output system (BIOS) stored in a read only memory (ROM) and one or more program modules such as operating systems, application programs and program data stored in random access memory (RAM). In some embodiments, the UE 500 can receive external memory devices, such as a smart card via a smart card reader that is coupled to the processor 510.

One or more communications devices 530 such as transceivers are coupled to the processor 510. The one or more communications devices 530 include, for example, an antenna to transmit and/or receive a radio communication, a network card or modem to transmit and/or receive a wired communication, and/or one or more other communications devices.

One or more user interface elements 540, such as a display, a touchscreen, a keypad, a keyboard, a biometric input, are coupled to the processor 510. The one or more user interface elements 540 enable the UE 500 to receive the input identifying a user of the UE 500 as described herein. The one or more user interface elements 540 can also enable the UE 500 to display feedback for the user during the method 200, the method 300 and the method 400.

In some embodiments, the memory 520 comprises instruction code 522 for performing one or more of the steps of the method 200, the method 300 or the method 400 at the UE 120. In some embodiments, the memory 520 comprises instruction code 522 for receiving an input identifying a user of the UE; transmitting, to an identity management system, one or more credentials based on the input; receiving, from the identity management system, user data comprising a MSISDN attribute corresponding to the user; and transmitting, to a registrar, an IMPI associated with the UE and an IMPU based on the MSISDN attribute.

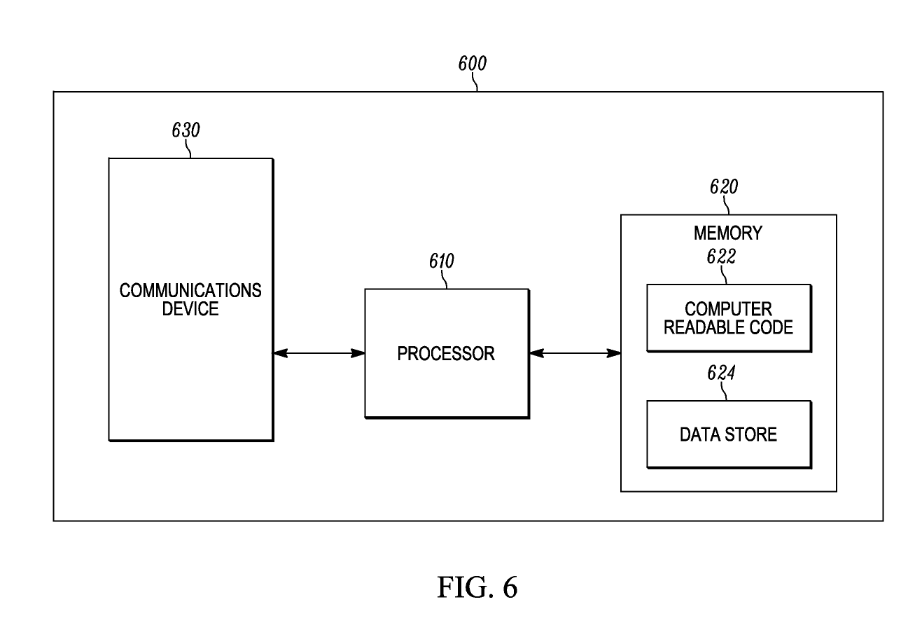

FIG. 6 is a schematic of an identity management system 600 in accordance with some embodiments. The identity management system 600 is, for example, identical to the identity management system 140.

The identity management system 600 comprises a processor 610 and a memory 620 coupled to the processor 610. The memory 620 comprises instruction code 622 for implementing various aspects of the present invention including various methods and functions of the embodiments described herein. The processor 610 processes the computer instruction code 622 stored in the memory 620 and executes corresponding instructions. In some embodiments, the memory 620 comprises instruction code 622 for performing one or more of the steps of method 200, the method 300 or the method 400 at the identity management system 140.

The memory 620 can also include a data store 624 to store data such as the MSISDN attributes and the home IMS domain attributes. For example, the data store 624 can comprise a database storing MSISDN attributes, home IMS domain attributes and corresponding user credentials or identities. For example, a block of MSISDNs is assigned to an agency stored as user attributes in an agency database, such as a Light-weight Directory Access Protocol (LDAP) server. As will be understood by a person skilled in the art, a single memory, such as the memory 620, can be used to store both dynamic and static data. The structure of the memory 620 is well known to those skilled in the art and can include a basic input/output system (BIOS) stored in a read only memory (ROM) and one or more program modules such as operating systems, application programs and program data stored in random access memory (RAM).

One or more communications devices 630 are coupled to the processor 610. The one or more communications devices 630 include, for example, an antenna to transmit and/or receive a radio communication to one or more UEs, a network card or modem to transmit and/or receive a wired communication, and/or one or more other communications devices.

The registrar, the S-CSCF and HSS are, for example, any registrar, S-CSCF and HSS known in the art that are suitable for performing IMS registration.

Some embodiments of the present disclosure are applicable to public safety networks, such as First Responder Network (FirstNet), where a UE is shared between multiple users from an agency.

Advantages of some embodiments thus include an ability to assign a phone number dynamically to a UE such that a user is contactable at the same phone number on different UEs, and different users are contactable at different phone numbers on the same UE. This could be thought of as Bring Your Own Number (BYON). For example, a MSISDN and an IMPU are assigned to the UE based on which user is logged into the UE.

For example, consider that Officer Bob selects a UE and logs onto his agency's identity management system. Officer Bob's phone number is then assigned to the UE. Subsequently, consider that Officer Alice could log onto the same UE, and her phone number then would be assigned to the same UE.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for dynamic Internet Protocol (IP) Multimedia Subsystem (IMS) registration, the method comprising:
receiving at a user equipment (UE) an input identifying a user of the UE;
transmitting from the UE to an identity management system, one or more credentials based on the input;
receiving at the UE from the identity management system, user data comprising a Mobile Subscriber Integrated Services Digital Network-Number (MSISDN) attribute corresponding to the user; and
transmitting from the UE to a registrar, an IP Multimedia Private Identity (IMPI) associated with the UE and an IP Multimedia Public Identity (IMPU) based on the MSISDN attribute.

2. The method of claim 1, further comprising generating the IMPU at the UE based on the MSISDN attribute.

3. The method of claim 1, wherein the user data comprises the IMPU based on the MSISDN attribute.

4. The method of claim 1, wherein the user data further comprises a home IMS domain attribute corresponding to the user or to the MSISDN, and the method further comprises generating the IMPU at the UE based on the MSISDN attribute and the home IMS domain attribute.

5. The method of claim 1, wherein the user data comprises the IMPU and the IMPU is based on the MSISDN attribute and a home IMS domain attribute corresponding to the user or to the MSISDN.

6. The method of claim 1, wherein the input identifying the user comprises one or more of the following:
a username;
a password;
a 2-factor authentication;
a biometric input; and
a smart card input.

7. The method of claim 1, wherein transmitting one or more credentials from the UE to the identity management system forms part of an authentication to a home identity management system.

8. The method of claim 1, wherein the identity management system comprises a Security Token Service (STS) and the user data is received at the UE from the STS in the form of an identity token.

9. The method of claim 8, further comprising:
transmitting from the STS to an attribute provider (AP), a request for one or more attributes including the user data; and
receiving at the STS from the AP, the one or more attributes.

10. The method of claim 1, wherein the IMPI and IMPU are transmitted from the UE to the registrar as part of a Session Initiation Protocol (SIP) registration message requesting a binding between the IMPI and the IMPU.

11. The method of claim 1, further comprising:
receiving at the UE from the registrar, a confirmation that a binding between the IMPI and the IMPU is authorized.

12. The method of claim 1, wherein receiving an input identifying a user of the UE forms part of a log in of the user to the UE and the method further comprises:
receiving at the UE, a request to log the user out of the UE; and
in response to receiving the request to log the user out of the UE, transmitting, from the UE to the registrar, a request for IMS deregistration.

13. A user equipment (UE) comprising:
a transceiver;
a processor; and
a memory coupled to the processor, the memory comprising instruction code for:
receiving an input identifying a user of the UE;
transmitting, to an identity management system, one or more credentials based on the input;
receiving, from the identity management system, user data comprising a Mobile Subscriber Integrated Services Digital Network-Number (MSISDN) attribute corresponding to the user; and
transmitting, to a registrar, an Internet Protocol (IP) Multimedia Private Identify (IMPI) associated with the UE and an IP Multimedia Public Identify (IMPU) based on the MSISDN attribute.

14. The UE of claim 13, wherein the memory further comprises instruction code for generating the IMPU based on the MSISDN attribute.

15. The UE of claim 13, wherein the user data comprises the IMPU based on the MSISDN attribute.

16. The UE of claim 13, wherein the user data further comprises a home IMS domain attribute corresponding to the user and/or the MSISDN and wherein the memory further comprises instructional code that for generating the IMPU based on the MSISDN attribute and the home IMS domain attribute.

17. The UE of claim 13, wherein the user data comprises the IMPU and the IMPU is based on the MSISDN attribute and a home IMS domain attribute corresponding to the user or to the MSISDN.

18. The UE of claim 13, wherein the input identifying the user comprises one or more of the following:
a username;
a password;
a 2-factor authentication;
a biometric input; and
a smart card input.

19. The UE of claim 13, wherein transmitting one or more credentials to the identity management system forms part of an authentication to a home identity management system.

20. The UE of claim 13, wherein the user data is received from the identity management system in the form of an identity token.

21. The UE of claim 13, wherein the IMPI and the IMPU are transmitted to the registrar as part of a Session Initiation Protocol (SIP) registration message requesting a binding between the IMPI and the IMPU.

22. The UE of claim 13, wherein the memory further comprises instruction code for receiving from the registrar, a confirmation that a binding between the IMPI and the IMPU is authorized.

23. The UE of claim 13, wherein receiving an input identifying a user of the UE forms part of a log in of the user to the UE and the memory further comprises instruction code for:
receiving at the UE, a request to log the user out of the UE; and
in response to receiving the request to log the user out of the UE, transmitting, from the UE to the registrar, a request for IMS deregistration.
